(19) United States
(12) Patent Application Publication
(10) Pub. No.: US 2010/0175074 A1
(43) Pub. Date: Jul. 8, 2010

(54) HOST APPARATUS, METHOD OF CONTROLLING HOST APPARATUS, IMAGE FORMING SYSTEM, AND COMPUTER PROGRAM

(75) Inventor: Kentaro KANADA, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/652,649

(22) Filed: Jan. 5, 2010

(30) Foreign Application Priority Data
Jan. 7, 2009 (JP) 2009-001612

(51) Int. Cl. G06F 9/44

(52) U.S. Cl. 719/327

(57) ABSTRACT

A host apparatus which uses an image foaming apparatus forming an image includes: a first installer which installs a first device driver to use the image forming apparatus; a second installer which installs a second device driver, which has more setting items than the first device driver, to use the image forming apparatus; and a configuration selector which selects one of a first configuration where the first device driver is deleted and only the second device driver remains, when the second installer installs the second device driver, and a second configuration where both the first device driver and the second device driver remain.

### BACKGROUND

1. Technical Field

The present invention relates to a host apparatus, a method of controlling the host apparatus, an image forming system, and a computer program.

2. Related Art

In order to use a printer, it is necessary for a user to install a printer driver of the printer in a personal computer. For example, when the printer driver of the printer used by the user is contained in advance in a printer driver group embedded in an operating system (hereinafter, referred to as an OS) of the personal computer, the user can use the printer by installing the printer driver in the personal computer.

When a storage medium storing the printer driver is appended to the printer, the user can also install the printer driver stored in the storage medium in the personal computer. Alternatively, the user can gain access to the web site of a vendor that provides the printer by use of the personal computer to download the recent printer driver and install the recent printer drive in the personal computer. In either case, the user typically uses only the printer driver activating all functions of the printer regardless of a printing use.

A known technique which switches between a PDL (Page Description Language) printer driver and an image printer driver during printing is known (JP-A-11-265267). This known technique reduces data processing load by switching between the printer drivers in response to a command.

In the known technique, however, the printer driver has a configuration for realizing detailed and complex settings to use all of the functions of the printer. Therefore, even when the user wants simple printing, the user has to use the printer driver capable of realizing the detailed and complex settings, and thus the usability becomes low.

### SUMMARY

An advantage of some aspects of the invention is that it provides a host apparatus, a method of controlling the host apparatus, an image forming system, and a computer program capable of permitting a first device driver and a second device driver having more setting items than those of the first device driver to coexist in order to improve usability of a user. Another advantage of some aspects of the invention is that it provides a host apparatus, a method of controlling the host apparatus, an image forming system, and a computer program capable of switching a plurality of device drivers having different setting items in response to an instruction for a user.

According to an aspect of the invention, there is provided a host apparatus which uses an image forming apparatus forming an image. The host apparatus includes: a first installer which installs a first device driver to use the image forming apparatus; a second installer which installs a second device driver, which has more setting items than the first device driver, to use the image forming apparatus; and a configuration selector which selects one of a first configuration where the first device driver is deleted and only the second device driver remains, when the second installer installs the second device driver, and a second configuration where both the first device driver and the second device driver remain.

According to the host apparatus having this configuration, it is possible to select one of the configuration (the first configuration) where the second device driver having more setting items is used or the configuration (the second configuration) where the first device driver having less setting items and the second device driver having more setting items coexist. Accordingly, the usability for the user is improved.

The host apparatus according to the above aspect of the invention may further include a printer selector which uses one of the first and second device drivers depending on a use purpose of the image forming apparatus, when the configuration selector selects the second configuration.

According to the host apparatus having this configuration, it is possible to select one of the first device driver and the second device driver depending on the use purpose of the image forming apparatus. Accordingly, the usability for the user is improved. Examples of the use purpose include final output results obtained when the user wants a relatively simple printing product or a relatively complex printing product or operations executed when the user wants simple printing or wants to learn advanced settings.

The host apparatus according to the above aspect of the invention may further include a registration table used to register a device driver used by each application program in advance. The image forming apparatus selector may select one of the first and second device drivers by using the registration table.

According to the host apparatus having this configuration, it is possible to use the image forming apparatus capable of changing the device driver in each application program. Accordingly, the usability is improved.

In the host apparatus according to the above aspect of the invention, the image forming apparatus selector may select one of the first and second device drivers on the basis of an instruction of a user.

According to the host apparatus having this configuration, since the user can select a desired device driver, the usability is improved.

In the host apparatus according to the above aspect of the invention, when the configuration selector selects the second configuration, the configuration selector may generate a first display indicating the first device driver and a second display indicating the second device driver in a different way, and may display the first and second displays on a screen.

According to the host apparatus having this configuration, the user can distinguish the first device driver from the second device driver by use of elements of the first and second displays and can simply select the desired device driver. Here, examples of the elements of the first and second displays include the shape, color, name, or formation of an icon.

In the host apparatus according to the above aspect of the invention, the first device driver may be configured to use predetermined functions among functions of the image forming apparatus. The second device driver may be configured to use more functions among the functions of the image forming apparatus than the first device driver.

In the host apparatus according to the above aspect of the invention, the first device driver may be configured to correspond to plural kinds of apparatuses including the image forming apparatus. The second device driver may be configured to correspond only to the image forming apparatus.

The host apparatus according to the above aspect of the invention may further include a management unit which manages the second device driver. The second installer may acquire the second device driver from the management unit via a communication network and may install the second device driver.

### BRIEF DESCRIPTION OF THE DRAWINGS

The invention will be described with reference to the accompanying drawings, wherein like numbers reference like elements.

FIG. 1 is a diagram illustrating the entire configuration of a system.

FIG. 2 is a schematic diagram illustrating a relationship between a class driver and an exclusive-use driver.

FIG. 3 is a diagram illustrating a relationship among the class driver, a compatible ID, a device ID, and the exclusive-use driver.

FIG. 4 is a diagram illustrating a setting screen of the class driver.

FIG. 5 is a diagram illustrating a setting screen of the exclusive-use driver.

FIG. 6 is a diagram illustrating a screen of a host computer in printing.

FIG. 7 is a diagram illustrating a screen of an updater.

FIG. 8 is a diagram illustrating a screen displayed when the exclusive-use driver is installed.

FIG. 9 is a flowchart illustrating a process of installing a printer.

FIG. 10 is a flowchart illustrating an update process from the class driver to the exclusive-use driver.

FIG. 11 is a flowchart illustrating a process of installing the exclusive-use driver.

FIG. 12 is an explanatory diagram illustrating a case where a printer driver corresponds to each application program.

FIG. 13 is a flowchart illustrating processes including a process of registering a printer driver in a printer use registration table.

FIG. 14 is a flowchart illustrating a process of selecting a printer driver according to a second embodiment.

FIGS. 15A and 15B are diagrams showing that class printer driver and exclusive-use driver correspond to one printer icon.

### DESCRIPTION OF EXEMPLARY EMBODIMENTS

Hereinafter, exemplary embodiments of the invention will be described with reference to the drawings. In a system according to the embodiments, as described below, there is prepared a class driver 202 which is capable of forming an image only with minimum necessary settings and is used in plural kinds of apparatuses and an exclusive-use driver 203 which is capable of appropriately using all functions of an image forming apparatus with detailed settings and is used only in the image forming apparatus. In the embodiments, since the class driver 202 and the exclusive-use driver 203 can coexist, the class driver 202 and the exclusive driver 203 can be separately used in accordance with a use purpose (printing use).

### First Embodiment

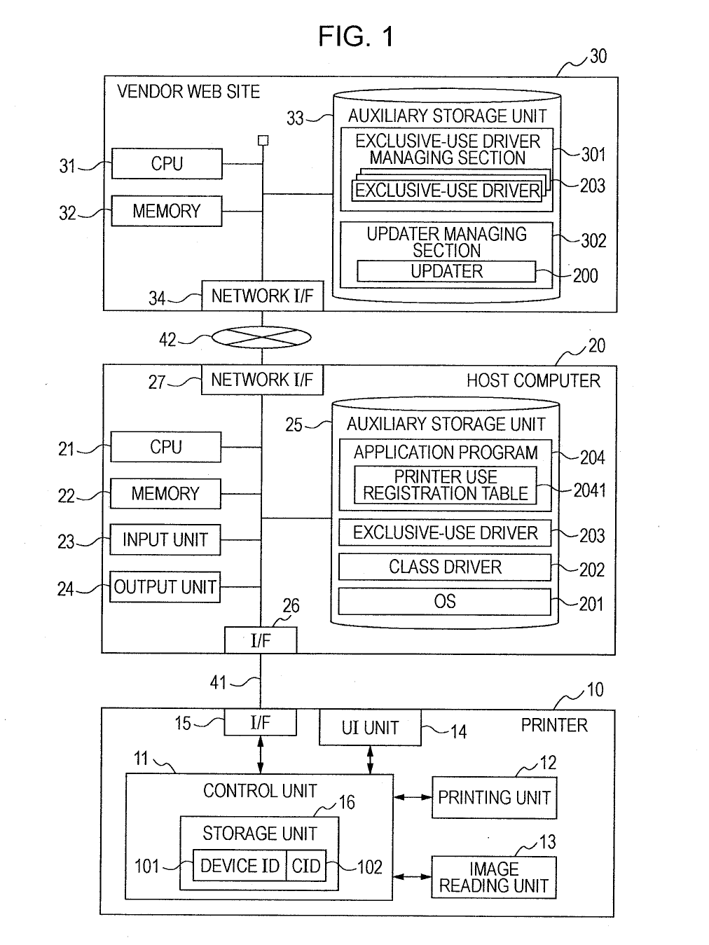

FIG. 1 is a diagram illustrating the entire configuration of a printing system, which is “an image forming system”. The image forming system includes a printer 10 which is “an image forming apparatus”, a host computer 20 which is “a host apparatus”, and a vendor web site 30 which is “a management apparatus”.

For example, the printer 10 includes a control unit 11, a printing unit 12, an image reading unit 13, a user interface unit 14 (UI unit 14), and a communication interface unit 15 (I/F 15).

The control unit 11 is a unit controlling the operation of the printer 10. For example, the control unit 11 generates printing image data on the basis of print data output from the host computer 20 and drive the printing unit 12. Alternatively, the control unit 11 drives the image reading unit 13 to read an image and outputs the read image data to the host computer 20.

The printing unit 12 is configured like an ink jet printing mechanism capable of executing serial printing or a laser printing mechanism capable of executing page printing. The printing unit 12 is capable of executing black-and-white printing or color printing.

The image reading unit 13 reads an image of a document placed on a document table to generate image data. Since the printer 10 includes the image reading unit 13, the printer 10 can be used like a copy apparatus. The printer 10 may not include the image reading unit 13.

The communication interface unit 15 is a circuit which communicates with a communication interface unit 26 of the host computer 20. The communication interface units 15 and 26 are connected to each other through a communication path 41. The host computer 20 and the printer 10 can communicate with each other using a USB (Universal Serial Bus) or an IEEE 1394, for example. Alternatively, the printer 10 and the host computer 20 may communicate with each other through a wireless LAN (Local Area Network) or infrared rays, or the like.

The user interface unit 14 includes a touch panel including a display unit and an input unit which are integrated or includes one or more switches and a display device. A user can confirm the details of setting since the user can give instruction to the printer 10 through the user interface unit 14.

An identification information storage unit and an expressive storage unit 16 are formed of a storage unit such as a semiconductor memory. The storage unit 16 stores a compatible ID 102 (CID 102) and a device ID 101. The compatible ID 102 is called first identification information and the device ID 101 is called second identification information.

As described in detail below, the compatible ID 102 can correspond to plural kinds of apparatuses. The device ID 101 can correspond to each kind of apparatus. That is, the exclusive-use device ID 101 can correspond to a kind of printer. Another device ID can correspond to a different kind of printer. In this way, one compatible ID 102 can correspond to both the kind of printer and the different kind of printer.

The device ID 101 and the compatible ID 102, which are integrated data, are stored in the storage unit 16. The host computer 20 analyzes data read from the storage unit 16 to extract the device ID 101 and the compatible ID 102.

Moreover, the storage unit 16 is formed inside the control unit 11 as a matter of convenience in FIG. 1, but the storage unit 16 may be formed outside the control unit 11. Alternatively, a storage unit storing the device ID 101 and a storage unit storing the compatible ID 102 may be separated.

For example, the host computer 20 is formed of a computer such as a personal computer, a cellular phone, or a portable information terminal. For example, the host computer 20 includes a microprocessor 21 (CPU 21), a memory 22, an input unit 23, an output unit 24, an auxiliary storage unit 25, the communication interface unit 26, and a network interface unit 27.

The auxiliary storage unit 25 is formed of a hard disk or a non-volatile storage unit such as a flash memory device. The auxiliary storage unit 25 stores the OS 201, the class driver 202, which is “the first device driver”, the exclusive-use driver 203, which is “the second device driver”, and an application program 204, for example.

Examples of the application program 204 includes document generation software, spreadsheet software, drawing software, and photo processing software. The application program 204 includes a printer use registration table 2041 which is “a registration table”. A printer driver used by the application program 204 is registered in the printer use registration table 2041.

When the host computer 20 is activated, a variety of programs such as the OS 201 or data are read from the auxiliary storage unit 25 and stored in the memory 22. When the CPU 21 reads the programs stored in the memory 22 and executes the programs, each process described below is executed.

The input unit 23 is a unit which inputs an instruction or the like from the user into the host computer 20. The input unit 23 is formed of a keyboard switch, a pointing device, or a microphone, for example. The output unit 24 is formed as a display device, for example. The output unit 24 may include a speaker.

The network interface unit 27 is a circuit which executes communication with the vendor web site 30. For example, the network interface unit 27 is connected to a network interface unit 34 of the vendor web site 30 through a communication network 42 such as the Internet.

The vendor web site 30 is a vendor web site which supplies the printer 10 to the market. For example, the vendor web site 30 is formed as a server computer which includes a microprocessor 31, a memory 32, an auxiliary storage unit 33, and the network interface unit 34.

The auxiliary storage unit 33 stores an updater managing section 302 and an exclusive-use managing section 301 as well as an OS or a web server program (all of which are not shown). The updater managing section 302 is a computer program which manages an updater 200 (see FIG. 7) which serves as “a device driver update unit”. The exclusive driver managing section 301 manages the exclusive-use driver 203 corresponding to each of plural kinds of printers provided from a vendor.

The vendor web site 30 detects the exclusive-use driver 203 corresponding to the device ID on the basis of the device ID input from the host computer 20, and transmits the detected exclusive-use driver 203 to the host computer 20.

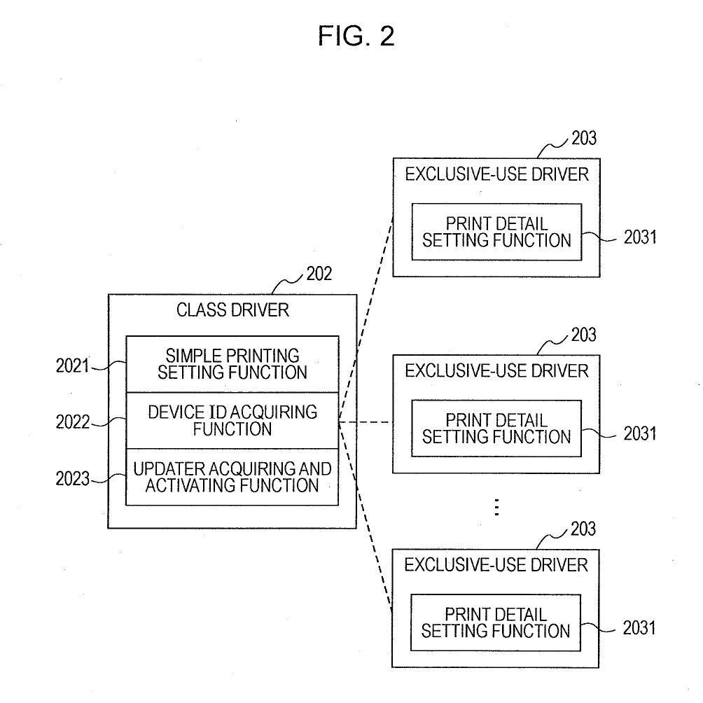

FIG. 2 is an explanatory diagram schematically illustrating a relationship between the class driver 202 and the exclusive-use driver 203 and the configurations thereof.

The class driver 202 is a simple general printer driver which can correspond to plural kinds of printers. For example, the class driver 202 includes a simple printing function 2021, a device ID acquiring function 2022, and an updater acquiring and activating function 2023.

The simple printing function 2021 refers to a function of causing the printer 10 to execute the printing with the minimum necessary settings such as a sheet size or the copy number of sheets. The device ID acquiring function 2022, which is “a second identification information acquiring unit” refers to a function of acquiring the device ID 101 from the storage unit 16 of the printer 10. The updater acquiring and activating function 2023 refers to a function of acquiring and activating an updater corresponding to the device ID 101 from the updater managing section 302 of the vendor web site 30.

The exclusive-use driver 203 includes a print detail setting function 2031 of setting a printer corresponding to this exclusive-use driver 203. The user can appropriately use all of the functions of the printer by using the print detail setting function 2031.

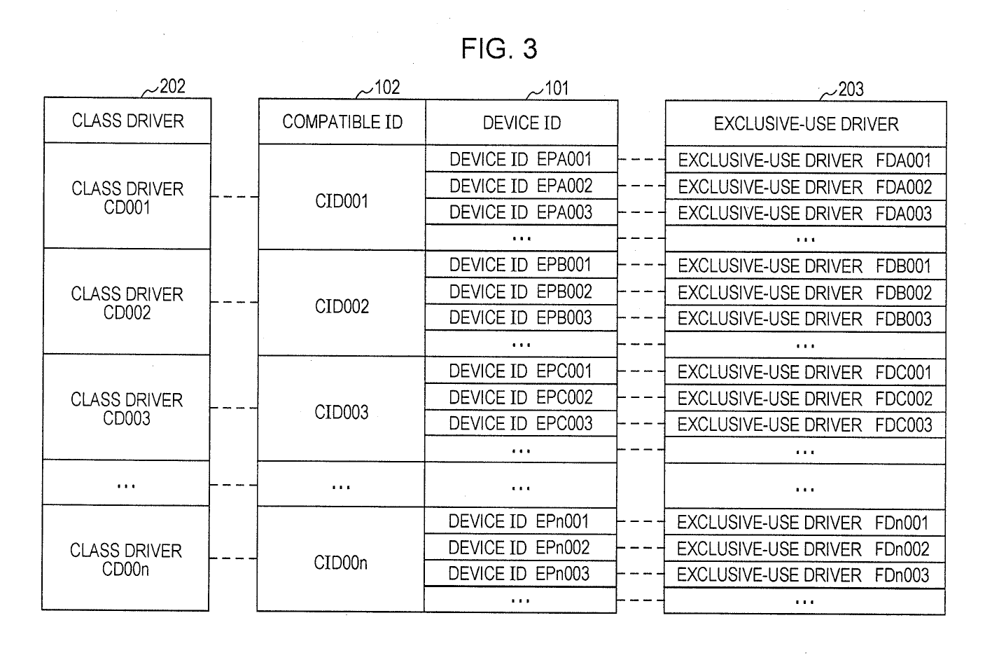

FIG. 3 is an explanatory diagram illustrating a relationship among the class driver 202, the compatible ID 102, the device ID 101, and the exclusive-use driver 203. As described above, the compatible ID 102 can correspond to plural kinds of apparatuses. The class driver 202 can correspond to each compatible ID 102. Accordingly, the class driver 202 corresponding to the printer can be specified on the basis of the compatible ID 102.

The compatible ID 102 can correspond to plural kinds of printers. In addition, each different device ID 101 is prepared for each kind of printer. Accordingly, the compatible ID 102 can correspond to plural device IDs 101.

Each device ID 101 corresponds to each kind of printer and each exclusive-use driver 203 is prepared for each kind of printer. Accordingly, on the basis of the device ID 101 acquired from the printer, the exclusive-use driver 203 corresponding to the printer can be specified.

As described in FIG. 1, the device ID 101 and the compatible ID 102 are stored in the storage unit 16 of the printer 10. Accordingly, as described below, the host computer 20 can acquire the compatible ID 102 from the printer 10 to specify and use the class driver 202 corresponding to the printer. Moreover, the host computer 20 can acquire the device ID 101 from the printer 10 to specify and use the exclusive-use driver 203 of the printer.

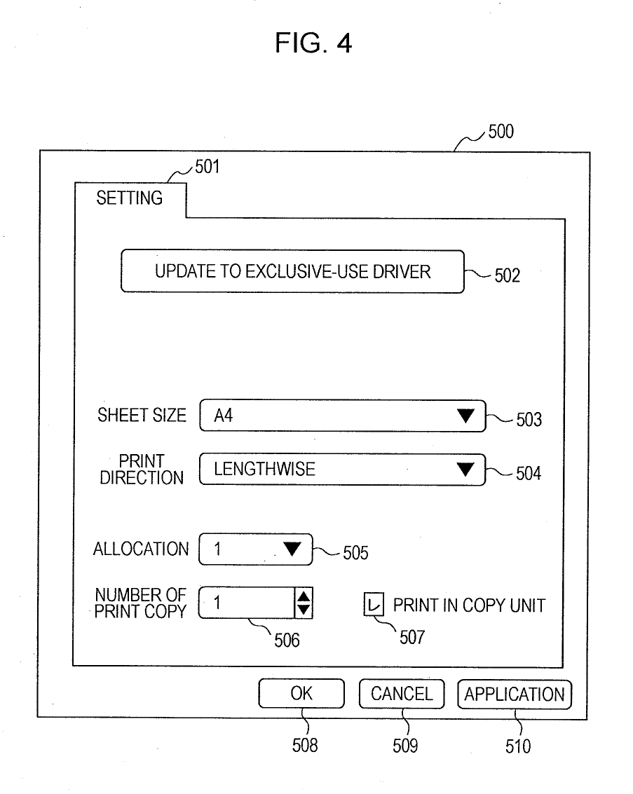

FIG. 4 is a diagram illustrating a setting screen 500 of the class driver 202. The setting screen 500 contains one tap menu 501, for example. For example, the tap menu 501 contains an update instruction button 502, a sheet size setting section 503, a print direction setting section 504, an allocation setting section 505, a print copy setting section 506, a copy unit print setting section 507, an OK button 508, a cancel button 509, and an application button 510.

The update instruction button 502 is used for the user to instruct the update from the class driver 202 to the exclusive-use driver 203. The sheet size setting section 503 is used for the user to set the size of a print sheet. For example, the user can select one sheet size in the relatively small selection range such as an A5 size or an A4 size. In this embodiment, for example, the selectable maximum size is the A4 size in the class driver 202 and the printing cannot be executed on a sheet with a size larger than the A4 size.

The print direction setting section 504 is used to designate a print direction, that is, a direction of the print sheet. For example, the user can select either a “lengthwise” direction or a “widthwise” direction as the print direction. The allocation setting section 505 is used for the user to set the number of images allocated on the print sheet. The print copy setting section 506 is used for the user to set a print copy number. The copy unit print setting section 507 is used for the user to set whether the printing is executed in the copy unit.

The functions used in the class driver 202 are not limited to the functions shown in FIG. 4. For example, functions other than the functions shown in FIG. 4 may be used in the class driver 202. On the contrary, some of the functions shown in FIG. 4 may not be used.

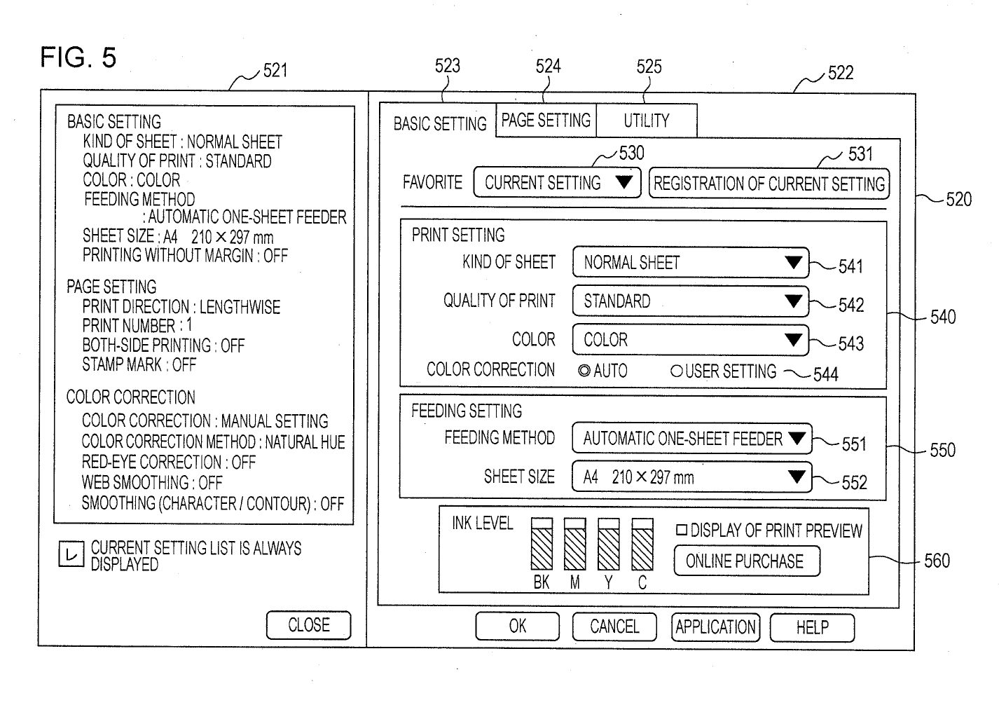

FIG. 5 is a diagram illustrating a setting screen 520 of the exclusive-use driver 203. The exclusive-use driver 203 can use all of the functions of the printer 10. Accordingly, the setting screen 520 of the exclusive-use driver is configured so as to realize the print setting in more detail, compared to the setting screen 500 of the class driver.

The setting screen 520 of the exclusive-use driver contains a setting list display section 521 and a tap menu section 522, for example. The setting list display section 521 displays the details of current setting. For example, the tap menu section 522 contains a basic setting menu 523, a page setting menu 524, and a utility menu 525.

For example, the basic setting menu 523 contains a selection portion 530 used to select the existing setting, a registration portion 531 used to store the current setting details so as to reuse the current setting details, a print setting portion 540, a feeding setting portion 550, and an ink level managing portion 560.

The print setting portion 540 contains a sheet kind setting portion 541, a print quality setting portion 542, a color print setting portion 543, and a color correction setting portion 544. The sheet kind setting portion 541 is used for the user to select and set the kind of print sheet. Examples of the kind of print sheet include a normal sheet and an exclusive-use gloss sheet. The print quality setting portion 542 is used for the user to select and set the print quality. Examples of the print quality include “standard”, “good”, and “high-speed”. The color print setting portion 543 is used for the user to select and set color printing or black-and-white printing. The color correction setting portion 544 is used for the user to set a method of correcting colors.

The feeding setting portion 550 may contain a feeding method setting portion 551 and a sheet size setting portion 552. The feeding method setting portion 551 is used for the user to select and set a feeding method. Examples of the feeding method include “an automatic one-sheet feeder” and “manual feeding”. The sheet size setting portion 552 is used for the user to select and set the size of the print sheet. Examples of the size of the print sheet include an A3 size, an A4 size, a B4 size, a B5 size, and a postcard size.

The ink level managing portion 560 is used to manage the level of the ink remaining in an ink tank included in the printing unit 12. The ink level managing portion 560 displays the level of the ink of each color. In FIG. 5, ink of four colors is used. However, the invention is not limited thereto. Ink of four or less colors may be used or ink of five or more colors may be used.

In the page setting menu 524, for example, the print direction, the print copy number, both-side printing, and printing of a stamp mark can be set.

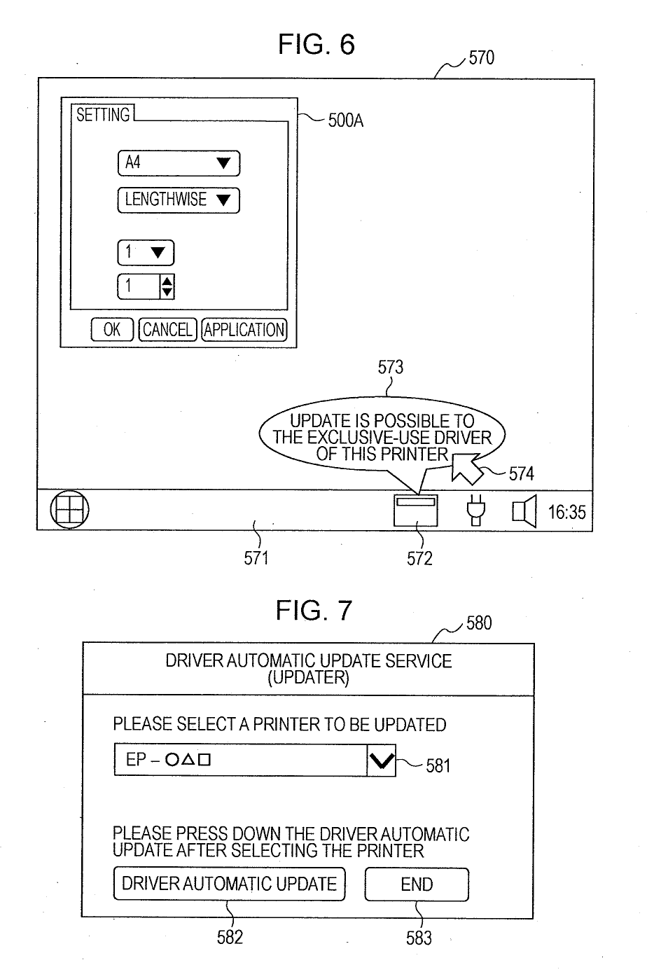

FIG. 6 is an explanatory diagram illustrating an example of a screen 570 displayed on an output unit 24 of the host computer 20 in the printing executed using the class driver 202. On the screen 570, a setting screen 500A of the class driver is displayed. The setting screen 500A does not contain the update instruction button 502 unlike the setting screen 500 shown in FIG. 4.

Instead, the screen 570 contains a balloon help 573. For example, the balloon help 573 can display characters such as “Update is possible to the exclusive-use driver of this printer”. The balloon help 573 can be displayed near a printer icon 572 displayed in a task bar 571.

When the user clicks the balloon help 573 with a mouse pointer 574, the update to the exclusive-use driver 203 is instructed from the class driver 202. Accordingly, the setting screen 500A of the class driver on the screen 570 does not contain the update instruction button 502. This is because an update instruction can be given by operating the balloon help 573. Alternatively, the setting screen 500 containing the update instruction button 502 may be displayed on the screen 570. In this case, the user can give the update instruction by operating one of the update instruction button 502 or the balloon help 573.

FIG. 7 is a diagram illustrating a screen 580 of the updater. When the update is carried out from the class driver 202 to the exclusive-use driver 203, the updater is downloaded from the updater managing section 302 of the vendor web site 30 to the host computer 20. When the updater is activated, the screen 580 shown in FIG. 7 is displayed on the output unit 24 of the host computer 20.

The screen 580 of the updater may contain a printer designation portion 581, a driver update instruction button 582, and an end button 583. The printer designation portion 581 is used for the user to designate the kind of printer for which a driver is necessary to be updated. When the user knows the kind of printer, the user can specify the device ID. The driver update instruction button 582 is used for the user to determine the update from the class driver 202 to the exclusive-use driver 203. The end button 583 is used for the user to end the update from the class driver 202 to the exclusive-use driver 203.

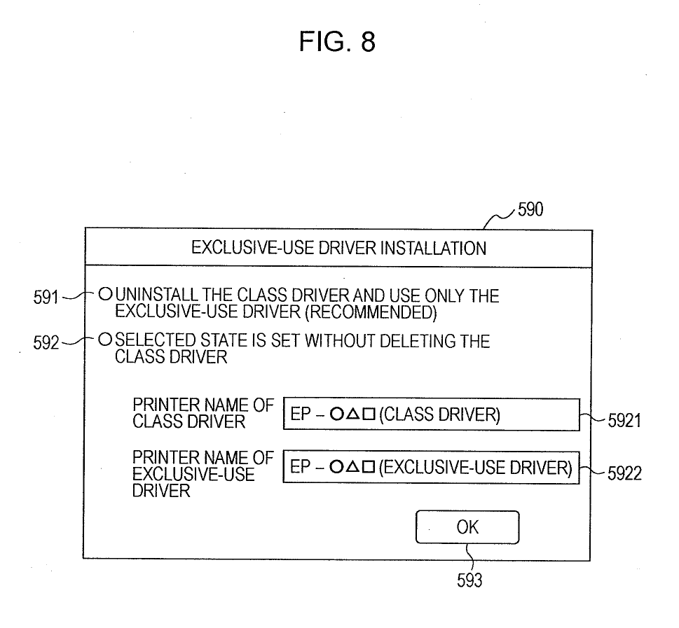

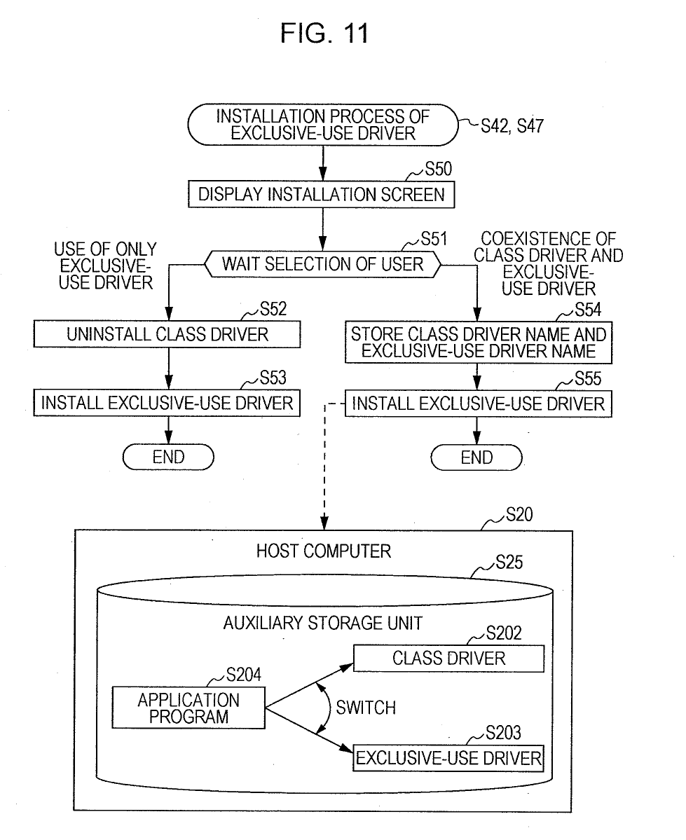

FIG. 8 is a diagram illustrating an exclusive-use driver installation screen 590 displayed when the exclusive-use driver 203 is installed. The installation screen 590 contains a first configuration selection portion 591, a second configuration selection portion 592, and an OK button 593. The installation screen 590 contains a process shown in FIG. 11 and a “configuration selector”.

The first configuration selector 591 is used to select a first configuration. The first configuration refers to a configuration of using only the exclusive-use driver 203. When the first configuration is selected, the class driver 202 is uninstalled and only the exclusive-use driver 203 is installed. However, since the class driver 202 is embedded in the OS 201, the class driver 202 can be reinstalled, if necessary.

The second configuration selection portion 592 is used to select a second configuration. The second configuration refers to a configuration of using one of the class driver 202 and the exclusive-use driver 203 since the class driver 202 and the exclusive-use driver 203 coexist. The second configuration selecting portion 592 includes a class driver name 5921 and an exclusive-use driver name 5922. The class driver name 5921 is a name indicating the class driver 202 and corresponds to a “first display”. The exclusive-use driver name 5922 is a name indicating the exclusive-use driver 203 and corresponds to a “second display”.

The class driver name 5921 is made by adding a display such as a “class driver” or a “simple setting board” to a normal printer name, for example, so that the user can easily identify the class driver 202.

The exclusive-use driver name 5922 is made by adding a display such as “an exclusive driver” or “an advanced function board” to a normal printer name, for example, so that the user can easily identify the exclusive-use driver 203.

The user can change both the class driver name 5921 and the exclusive-use name 5922 to the user's favorite names. The user selects one of the first configuration selection portion 591 and the second configuration selection portion 592 to press down an OK button 593.

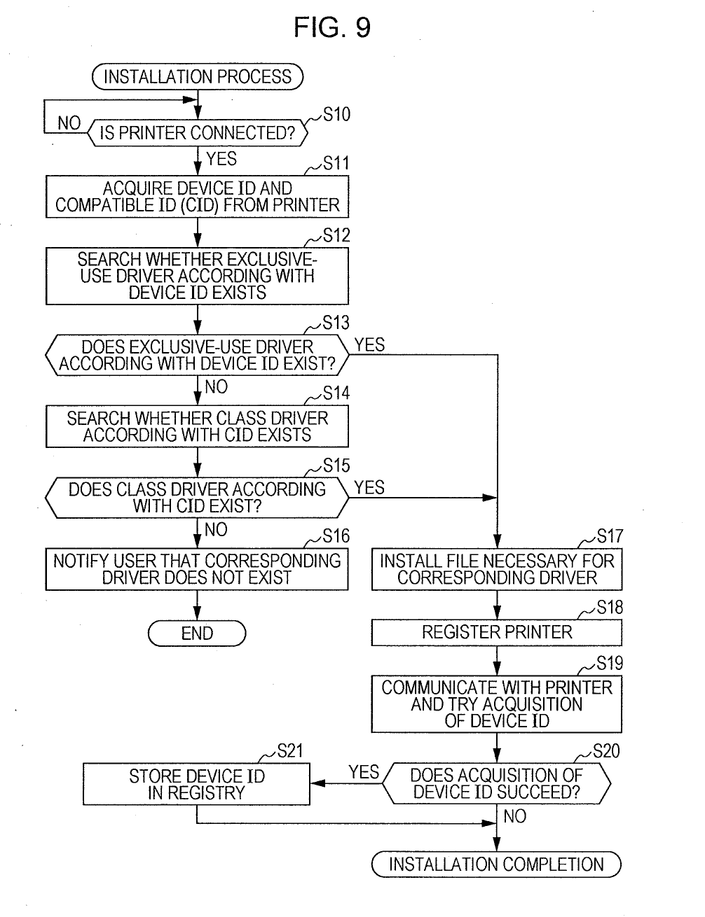

FIG. 9 is a flowchart illustrating a process when the printer 10 is installed in the host computer 20. Processes in steps S10 to S18 are executed by the OS 201 and processes in steps S19 to S21 are executed by the class driver 202.

The OS 201 determines whether the printer 10 is connected to the host computer 20 (S10). When the printer 10 is connected to the host computer 20 (S10: YES), the OS 201 acquires the device ID 101 and the compatible ID 102 (hereinafter, referred to as a CID 102) from the printer 10 through the communication path 41 (S11).

The OS 201 searches the exclusive-use driver 203 according with the device ID (S12) and determines whether the exclusive-use driver 203 according with the device ID exists (the exclusive-use driver 203 is added in the OS 201) (S13). For example, when a new printer 10 is launched in the market after the release of an OS, the OS 201 does not contain the exclusive-use driver 203 thereof.

When the exclusive-use driver 203 according with the device ID (S13: NO) is not contained, the OS 201 searches the class driver 202 according with the CID (S14). The OS 201 determines whether the class driver 202 according with the CID exists (S15).

When the class driver 202 is also not contained (S15: NO), the OS 201 reports a notice that the printer to be installed is not found, by displaying a message on the screen of the output unit 24 (S16). The user receiving the notice gains access to the vendor web site 30 and manually searches a desired printer driver, for example.

Alternatively, when the exclusive-use driver 203 according with the device ID is found (S13: YES) or when the class driver 202 according with the CID is found (S15: YES), the OS 201 installs a file necessary to use the found printer driver by using a system definition file (INF file) (S17). Subsequently, the OS 201 registers the installed printer driver (S18).

Here, a case where the exclusive-use driver 203 is not found (S13: NO) and only the class driver 202 is found will be described (S15: YES). Therefore, the class driver 202 is installed in the host computer 20 (S17) and is registered (S18).

The class driver 202 communicates with the printer 10 by using the interface unit 26 or the like to acquire the device ID from the printer 10 (S19). The class driver 202 determines whether the acquisition of the device ID from the printer 10 succeeds (S20). The class driver 202 stores the acquired device ID in a registry (S21) and ends the installation process, when the acquisition of the device ID succeeds (S20: YES). Alternatively, the class driver 202 ends the installation process, when the acquisition of the device ID does not succeed (S20: NO).

Moreover, when the exclusive-use driver 203 according with the device ID is found (S13: YES), the exclusive-use driver 203 is installed and registered (S17 and S18). The exclusive-use driver 203 may communicate with the printer 10 to acquire the device ID (S19 to S21). Alternatively, when the exclusive-use driver 203 is installed and registered (S17 and S18), the installation process may end without trying the acquisition of the device ID.

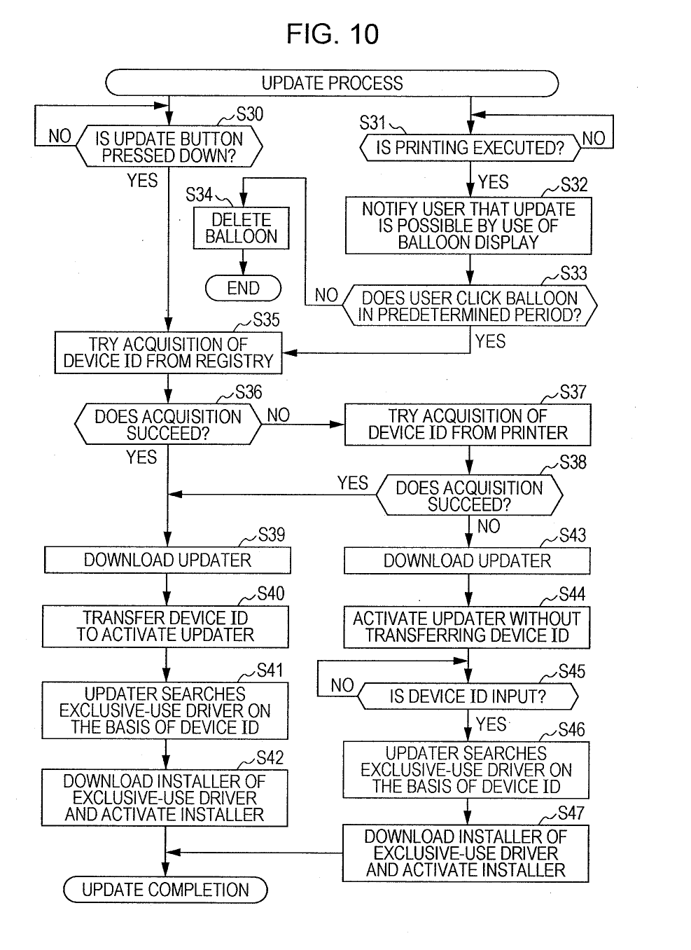

FIG. 10 is a flowchart illustrating an update process of executing the update from the class driver 202 to the exclusive-use driver 203. Among steps shown in FIG. 9, steps S30 to S40, S43, and S44 are executed by the class driver 202. Steps S41, S42, and S45 to S47 are executed by the updater 200.

An update instruction used to stat the update process can be given to the host computer 20 in a plurality of methods. In one method, the update instruction button 502 contained in the setting screen 500 of the class driver 202 shown in FIG. 4 is operated (S30).

In another method, the user clicks the balloon help 573 (see FIG. 6) displayed on the screen 570 in the printing (S31). That is, the class driver 202 displays the balloon help 573 to notify the user that the update to the exclusive-use driver 203 is possible (S32), when the user operates the print button of an application program to execute the printing (S31: YES).

When the user clicks the balloon help 573 in a predetermined period (S33: YES), the update instruction is given. When the user does not click the balloon help 573 in the predetermined period (S33: NO), the balloon help 573 is cleared (S34) and the update process ends.

When the update instruction button 502 is operated (S30: YES) or when the balloon help 573 is operated (S33: YES), the class driver 202 tries the acquisition of the device ID from the registry (S35). The class driver 202 determines whether the reading of the device ID from the registry succeeds (S36).

When the device ID is acquired from the printer 10 in steps S19 to S21 in FIG. 8 and the device ID is stored in the registry, the class driver 202 can acquire the device ID from the registry (S36: YES).

The class driver 202 gains access to the vendor web site 30 through the network interface unit 27 or the like to download the updater 200 from the updater managing section 302 (S39). The class driver 202 transfers the device ID acquired in S35 to the downloaded updater 200 and activates the updater 200 (S40).

The updater 200 searches the exclusive-use driver 203 in the exclusive-use driver managing section 301 on the basis of the input device ID (S41) and downloads an installer of the exclusive-use driver 203 corresponding to the device ID to activate the installer (S42).

In this way, the exclusive-use driver 203 is installed in the host computer 20, and then the user executes the setting of the printing by using the exclusive-use driver 203. Accordingly, the user can obtain a desired printing product by freely using the functions of the printer 10.

When the class driver 202 cannot acquire the device ID from the registry (S36: NO), the class driver 202 tries the acquisition of the device ID from the printer 10 (S37). Alternatively, when the class driver 202 can acquire the device ID from the printer 10 (S38: YES), Steps S39 to S42 described above are executed.

When the device ID cannot be acquired from the printer 10 (S38: NO), the class driver 202 downloads the updater 200 from the vendor web site 30 (S43). Subsequently, the class driver 202 activates the updater 200 without transferring the device ID (S44).

The updater 200 prompts the user with the screen 580 shown in FIG. 7, for example, to request the input of the device ID (the input of the kind of printer) to the user (S45). The updater 200 searches the exclusive-use driver 203 corresponding to the device ID from the exclusive-use managing section 301 on the basis of the device ID which has been input manually from the user (S46). The class driver 202 downloads the installer of the found exclusive-use driver 203 from the exclusive-use managing section 301 and activates the installer (S47).

FIG. 11 is a flowchart illustrating the installation process of the exclusive-use driver 203 which is executed in S42 and S47 in FIG. 10. When the installation process of the exclusive-use driver 203 starts, the host computer 20 displays an installation screen 590 shown in FIG. 8 (S50). The host computer 20 waits until the user selects one of the first configuration selector 591 and the second configuration selector 592 (S51).

When the user operates the first configuration selector 591, the host computer 20 uninstalls the class driver 202 (S52) and installs the exclusive-use driver 203 (S53).

Alternatively, when the user operates the second configuration selector 592, the host computer 20 stores the class driver name 5921 and the exclusive-use driver name 5922 approved by the user (S54) and installs the exclusive-use driver 203 (S55).

When the user selects the second configuration (S54 and S55), as shown in the lower part of FIG. 11, one of the class driver 202 and the exclusive-use driver 203 can correspond to the application program 204. The user can select a desired printer driver between the drivers 202 and 203 depending on the printing use.

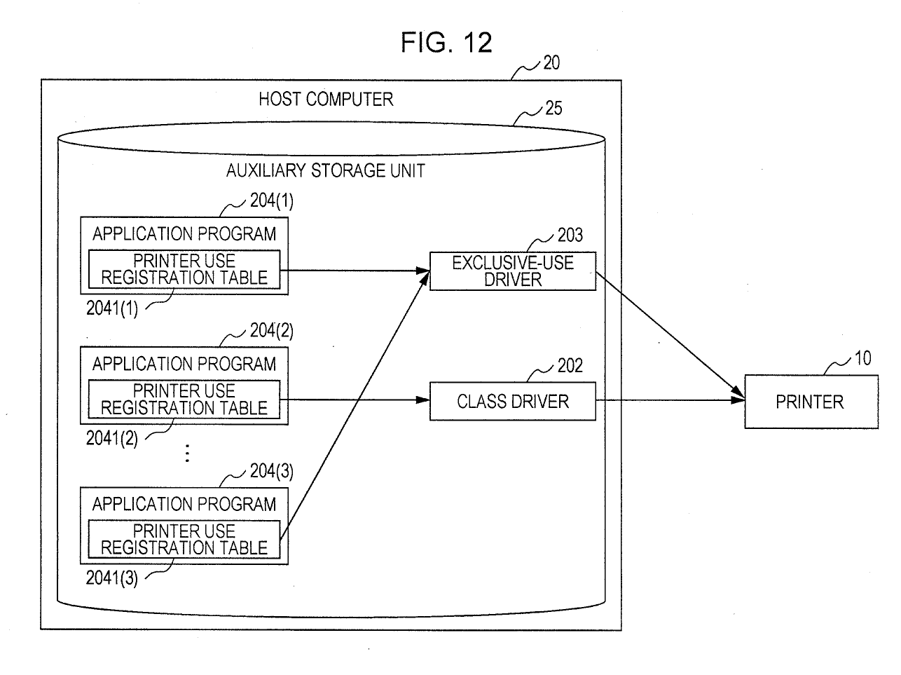

FIG. 12 is a diagram illustrating a configuration example of a case where the printer driver corresponding to the application program 204 is set in advance in every application program 204. For example, application programs 204(1) and 204(3) can correspond to the exclusive-use driver 203 by printer use registration tables 2041(1) and 2041(3), respectively. Another application program 204(2) can correspond to the class driver 202 by a printer use registration table 2041(2).

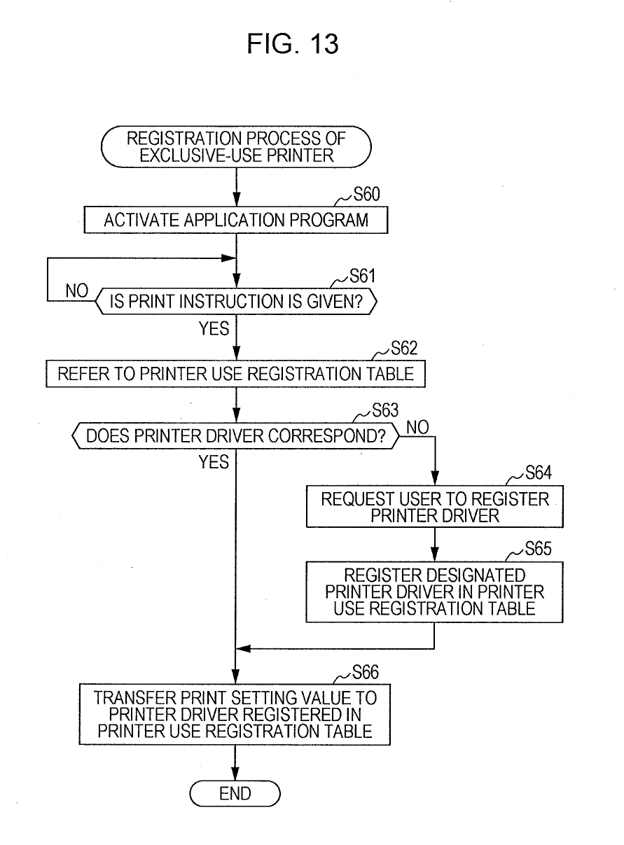

FIG. 13 is a flowchart illustrating a corresponding process of the printer (more specifically, the printer driver) by use of the application program 204.

When the application program 204 is activated (S60), the application program 204 determines whether a print instruction is given from the user (S61). When the print instruction is given from the user (S61: YES), the application program 204 refers to the printer use registration table 2041 (S62) and determines whether the printer driver corresponds to the application program 204 (S63).

When the printer driver does not correspond to the application program 204 (S63: NO), the application program 204 asks the user to register the printer driver (S64). For example, the application program 204 displays a message such as “Please register the printer driver using this application program” on a screen.

The user designates either the class driver 202 or the exclusive-use driver 203. Then, the designated printer driver is registered in the printer use registration table 2041 of the application program 204 (S65).

The host computer 20 transfers setting values used for the printing to the printer driver registered in the printer use registration table 2041 (S66). When the printer driver can correspond to the application program 204 (S63: YES), steps S64 and S65 are skipped and the process proceeds to step S66.

The following advantages can be obtained according to this embodiment. In this embodiment, the class driver 202 usable in the plural kinds of printers is prepared, and the class driver 202 corresponding to the CID 102 of the printer 10 is installed in the host computer 20. Accordingly, even in a new printer 10 launched after the release of the OS 201, the user can use the minimum printing functions by using the class driver 202.

In this embodiment, the exclusive-use driver 203 corresponding to the device ID can be installed at timing instructed by the user whether to update the class driver 202 to the exclusive-use driver 203 or to coexist the class driver 202 and the exclusive-driver 203. Accordingly, the plurality of printer drivers having different setting items can correspond to one printer 10, thereby improving usability for the user.

The user that wants detailed setting can use the exclusive-use driver 203 and the user that wants only simple setting can use the class driver 202. The user that wants to use only the exclusive-use driver 203 can uninstall the class driver 202 when the exclusive-use driver 203 is installed.

In this embodiment, the class driver name 5921 is prepared as a user interface display representing the class driver 202 and the exclusive-use driver name 5922 is prepared as a user interface display representing the exclusive-use driver 203. In this embodiment, the user can set the names 5921 and 5922 to distinguish the class driver 202 from the exclusive-use driver 203. Accordingly, the usability for the user is improved.

In this embodiment, the printer driver used in each application program 204 can be registered in advance. Since the appropriate printer driver can be registered depending on work details (the printing use or the use purpose), the usability for the user is improved. For example, the class driver 202 can be permitted to correspond to an application program which prints only simple texts and the exclusive driver 203 can be permitted to correspond to an application program which outputs a complex printing product in which images and texts are mixed.

### Second Embodiment

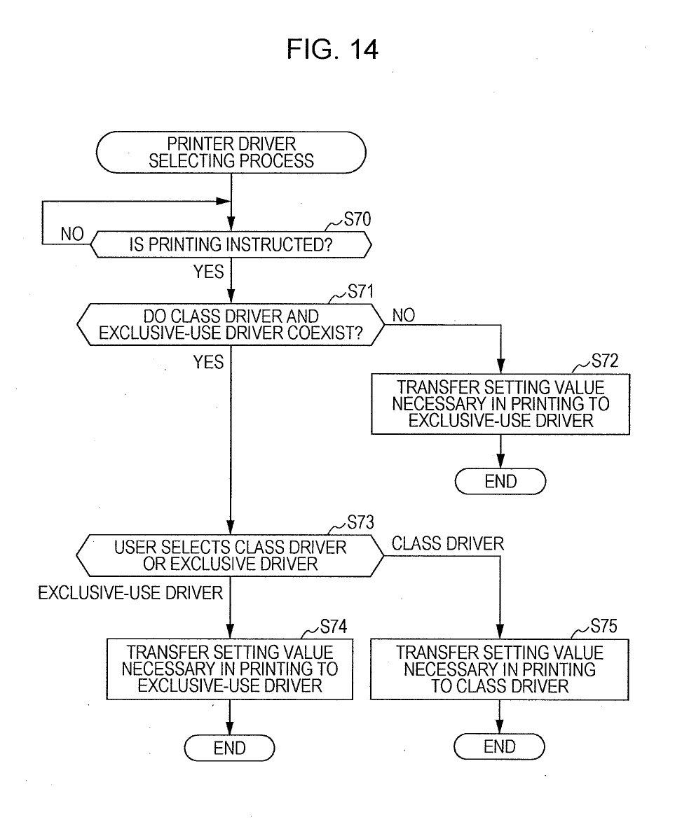

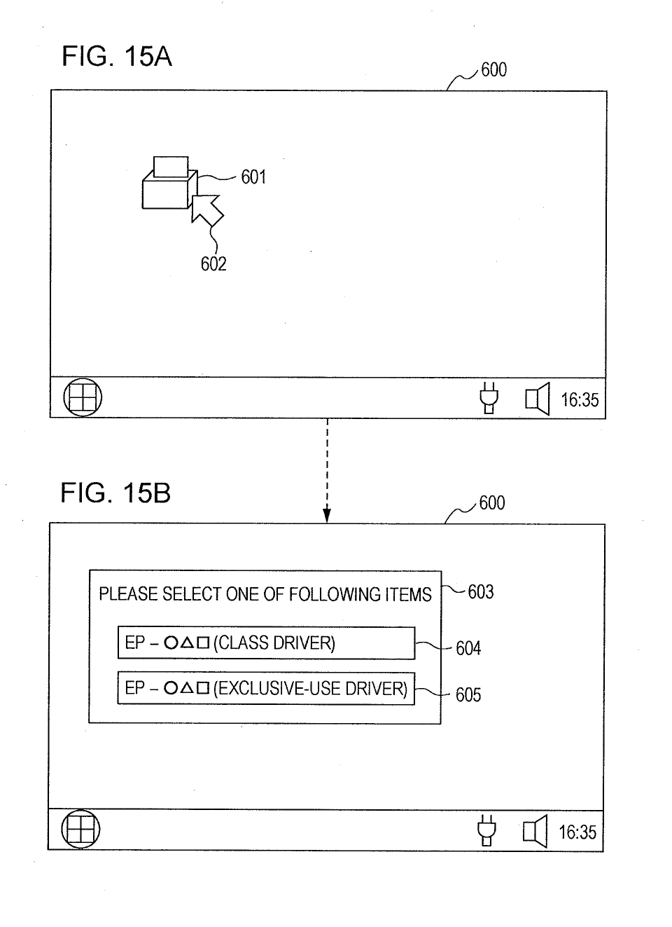

A second embodiment of the invention will be described with reference to FIG. 14 and FIGS. 15A and 15B. FIG. 14 is a flowchart illustrating a process of selecting a printer driver according to this embodiment. In the following embodiments including the second embodiment, details different from those of the first embodiment are mainly described.

In this embodiment, the user can instruct printing by operating a print instruction button contained in the application program 204 or a printer icon 601 (see FIGS. 15A and 15B) displayed on a screen (S70). When the printing is instructed (S70: YES), the application program 204 determines whether the class driver 202 and the exclusive-use driver 203 coexist (S71).

When the class driver 202 and the exclusive-use driver 203 do not coexist (S71: NO), that is, when only the exclusive-use driver 203 is installed (S71: NO), the application programs 204 transfers each setting value used in the printing to the exclusive-use driver 203 (S72).

Alternatively, when the class driver 202 and the exclusive-use driver 203 coexist (S71: YES), the application program 204 waits until the user selects one of the drivers 202 and 203 (S73).

When the exclusive-use driver 203 is selected, the application program 204 transfers each setting value necessary for the printing to the exclusive-use driver 203 (S74). Alternatively, when the class driver 202 is selected, the application program 204 transfers each setting value necessary for the printing to the class driver 202 (S75).

FIGS. 15A and 15B are explanatory diagrams showing that different plural printer drivers 202 and 203 correspond to one printer icon 601.

As shown in FIG. 15A, the printer icon 601 on a screen 600 is a symbol of the printer 10. When the user operates the printer icon 601 with a mouse pointer 602, a dialog 603 shown in FIG. 15B is displayed on the screen.

The dialog 603 contains a first selection portion 604 used to select the class driver 202 and a second selection portion 605 used to select the exclusive-use driver 203. The user can select one of the class driver 202 and the exclusive-use driver 203 by operating one of the selection portions 604 and 605.

Even in step S73 described above, the user is permitted to select the printer driver by displaying the dialog 603 appearing as a selection display.

In this embodiment, the same advantages as those of the first embodiment can be obtained. In this embodiment, the user can be permitted to select one of the class driver 202 and the exclusive-use driver 203 in the printing, since the class driver 202 and the exclusive-use driver 203 correspond to one printer icon 601. Accordingly, since the user can select an appropriate printer driver upon instructing the execution of the printing, the usability is improved.

The invention is not limited to the above-described embodiments. It is apparent to those skilled in the art that various additions or modifications can be made within the scope of the invention. For example, the printer has been described as an example of the image forming apparatus. However, the invention is not limited thereto, but is applicable to other image forming apparatuses such as a display apparatus.

What is claimed is:

1. A host apparatus which uses an image forming apparatus forming an image, comprising:
a first installer which installs a first device driver to use the image forming apparatus;
a second installer which installs a second device driver, which has more setting items than the first device driver, to use the image forming apparatus; and
a configuration selector which selects one of a first configuration where the first device driver is deleted and only the second device driver remains, when the second installer installs the second device driver, and a second configuration where both the first device driver and the second device driver remain.

2. The host apparatus according to claim 1, further comprising an image forming apparatus selector which uses one of the first and second device drivers depending on a use purpose of the image forming apparatus, when the configuration selector selects the second configuration.

3. The host apparatus according to claim 2, further comprising
a registration table used to register a device driver used by each application program in advance,
wherein the image forming apparatus selector selects one of the first and second device drivers by using the registration table.

4. The host apparatus according to claim 2, wherein the image forming apparatus selector selects one of the first and second device drivers on the basis of an instruction of a user.

5. The host apparatus according to claim 1, wherein when the configuration selector selects the second configuration, the configuration selector generates a first display indicating the first device driver and a second display indicating the second device driver in a different way, and displays the first and second displays on a screen.

6. The host apparatus according to claim 1,
wherein the first device driver is configured to use predetermined functions among functions of the image forming apparatus, and
wherein the second device driver is configured to use more functions among the functions of the image forming apparatus than the first device driver.

7. The host apparatus according to claim 1,
wherein the first device driver is configured to correspond to plural kinds of apparatuses including the image forming apparatus, and
wherein the second device driver is configured to correspond only to the image forming apparatus.

8. The host apparatus according to claim 1, further comprising:
a management unit which manages the second device driver,
wherein the second installer acquires the second device driver from the management unit via a communication network and installs the second device driver.

9. An image forming system comprising:
an image forming apparatus which forms an image; and
a host apparatus which uses the image forming apparatus,
wherein the host apparatus includes:
a first installer which installs a first device driver to use the image forming apparatus;
a second installer which installs a second device driver, which has more setting items than the first device driver, to use the image forming apparatus; and
a configuration selector which selects one of a first configuration where the first device driver is deleted and only the second device driver remains, when the second installer installs the second device driver, and a second configuration where both the first device driver and the second device driver remain.

10. A method of controlling a host apparatus using an image forming apparatus forming an image, the method comprising:
installing a first device driver to use the image forming apparatus;
selecting one of a first configuration where the first device driver is deleted and only the second device driver remains and a second configuration where both the first device driver and the second device driver remain, when installing a second device driver which has more setting items than the first device driver to use the image forming apparatus; and
installing the second device driver, after one of the first and second configurations is selected.
